(19) United States
(12) Patent Application Publication
(10) Pub. No.: US 2023/0225828 A1
(43) Pub. Date: Jul. 20, 2023

(54) DENTAL CONDENSER

(71) Applicant: Roman Fedorciw, Avon, CT (US)

(72) Inventor: Roman Fedorciw, Avon, CT (US)

(21) Appl. No.: 17/577,877

(22) Filed: Jan. 18, 2022

(51) Int. Cl. A61C 5/60; A61C 3/08

(52) U.S. Cl. CPC A61C 5/60; A61C 3/08

(57) ABSTRACT

A condensing tool for use in a dental application includes a shaft and a head arranged at an end of the shaft. A portion of the head is formed from a resilient material configured to deform when arranged in contact with an adjacent surface.

### BACKGROUND

Embodiments of the present disclosure relate to the restoration of a tooth, and more particularly, to a tool and a method of using such a tool during a restoration procedure.

Restoration of a tooth typically requires removing a decayed or damaged portion of a tooth and filling the missing portion or cavity of the tooth structure with a restorative material. Although several restorative materials, such as silver amalgam, gold, and porcelain, are known, tooth-colored composite materials are becoming more and more popular. Many composite restorative materials typically harden by a polymerization action that is initiated by light of a specific wavelength.

During restoration of a tooth, several layers of composite restorative material are installed to build up the restorative material or “filling.” Each of these layers is plugged or condensed causing the material to spread into the corners of the cavity formed in the tooth. In addition, each of these layers is cured prior to installation of the next layer. Excess restoration material is typically installed to adapt the restoration material with the cavosurface margin defined between the cavity and the tooth structure. This excess material is then carved or shaved to achieve a filling with desirable properties. However, it may be difficult to achieve complete adaptation to the cavosurface margin, leaving voids for recurrent decay. In addition, the incremental layering of restoration material creates potential for voids within the cavity.

### BRIEF DESCRIPTION

According to an embodiment, a condensing tool for use in a dental application includes a shaft and a head arranged at an end of the shaft. A portion of the head is formed from a resilient material configured to deform when arranged in contact with an adjacent surface.

In addition to one or more of the features described herein, or as an alternative, in further embodiments the resilient material is an elastomeric material.

In addition to one or more of the features described herein, or as an alternative, in further embodiments the elastomeric material satisfies an ISO 4823 type 3 standard.

In addition to one or more of the features described herein, or as an alternative, in further embodiments a resin material is in overlapping arrangement with the portion of the head being formed from the resilient material.

In addition to one or more of the features described herein, or as an alternative, in further embodiments the condensing tool is connectable to a handle as one of a plurality of interchangeable attachments.

According to an embodiment, a method of restoring a tooth includes filling a cavity formed in the tooth with a restorative material, smoothing the restorative material via a condensing tool, condensing the restorative material via the condensing tool, and curing the restorative material.

In addition to one or more of the features described herein, or as an alternative, in further embodiments smoothing and condensing the restorative material occurs simultaneously.

In addition to one or more of the features described herein, or as an alternative, in further embodiments smoothing and condensing the restorative material further comprises applying a pressure to the restorative material via the condensing tool and moving the condensing tool across an upper surface of the restorative material.

In addition to one or more of the features described herein, or as an alternative, in further embodiments applying the pressure to the restorative material via the condensing tool further comprises deforming the condensing tool against a surface of the tooth.

In addition to one or more of the features described herein, or as an alternative, in further embodiments deforming the condensing tool against the surface of the tooth maintains contact between the condensing tool and a cavosurface margin of the tooth.

In addition to one or more of the features described herein, or as an alternative, in further embodiments deforming the condensing tool against the surface of the tooth seals the restorative material against the cavosurface margin.

In addition to one or more of the features described herein, or as an alternative, in further embodiments comprising removing excess of the restorative material via the condensing tool.

In addition to one or more of the features described herein, or as an alternative, in further embodiments removing excess of the restorative material occurs simultaneously with at least one of the smoothing the restorative material and the condensing the restorative material.

In addition to one or more of the features described herein, or as an alternative, in further embodiments comprising coating a portion of the condensing tool configured to contact the restorative material with a resin material prior to at least one of the smoothing the restorative material and the condensing the restorative material.

In addition to one or more of the features described herein, or as an alternative, in further embodiments the cavity is filled with a single layer of the restorative material.

In addition to one or more of the features described herein, or as an alternative, in further embodiments the restorative material within the cavity is cured in a single operation.

### BRIEF DESCRIPTION OF THE DRAWINGS

The following descriptions should not be considered limiting in any way. With reference to the accompanying drawings, like elements are numbered alike:

FIG. 1 is a perspective view of an exemplary condenser tool according to an embodiment;

FIG. 2 is a cross-sectional view of a tooth having a cavity formed therein according to an embodiment;

FIG. 3 is a cross-sectional view of the tooth of FIG. 2 having an uncured restorative material arranged in the cavity according to an embodiment;

FIG. 4A is a plan view of a tooth having an uncured restorative material arranged within a cavity according to an embodiment;

FIG. 4B is a perspective side view of the tooth having an uncured restorative material arranged within a cavity of FIG. 4A according to an embodiment;

FIG. 4C is a perspective side view of a tooth having an uncured restorative material arranged within a cavity according to an embodiment;

FIG. 5A is a perspective side view of the tooth of FIG. 4B with a condenser tool applied to the restorative material according to an embodiment;

FIG. 5B is a perspective side view of the tooth of FIG. 4C with a condenser tool applied to the restorative material according to an embodiment;

FIG. 6 is cross-sectional view of the tooth of FIG. 3 having an uncured restorative material arranged within the cavity as the deformed condenser tool applies a pressure thereto according to an embodiment;

FIG. 7 is cross-sectional view of the tooth of FIG. 3 having an uncured restorative material arranged within the cavity after application of the condenser tool according to an embodiment;

FIG. 8A is a plan view of a tooth having an uncured restorative material arranged within a cavity after application of the condenser tool according to an embodiment; and

FIG. 8B is a perspective side view of a tooth having an uncured restorative material arranged within a cavity after application of the condenser tool according to an embodiment;

FIG. 9A is a perspective view of a tooth having excess uncured restorative material according to an embodiment;

FIG. 9B is a perspective view of a tooth having excess uncured restorative material removed by a plugger according to an embodiment;

FIG. 10 is a perspective view of the tooth of FIG. 9B after the excess uncured restorative material has been removed; and

FIG. 11 is a flow diagram of a method of performing restoration of a tooth using the condensing tool according to an embodiment.

### DETAILED DESCRIPTION

A detailed description of one or more embodiments of the disclosed apparatus and method are presented herein by way of exemplification and not limitation with reference to the Figures.

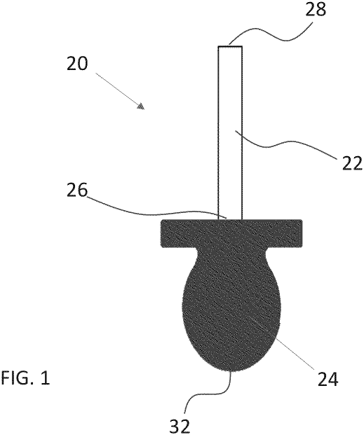

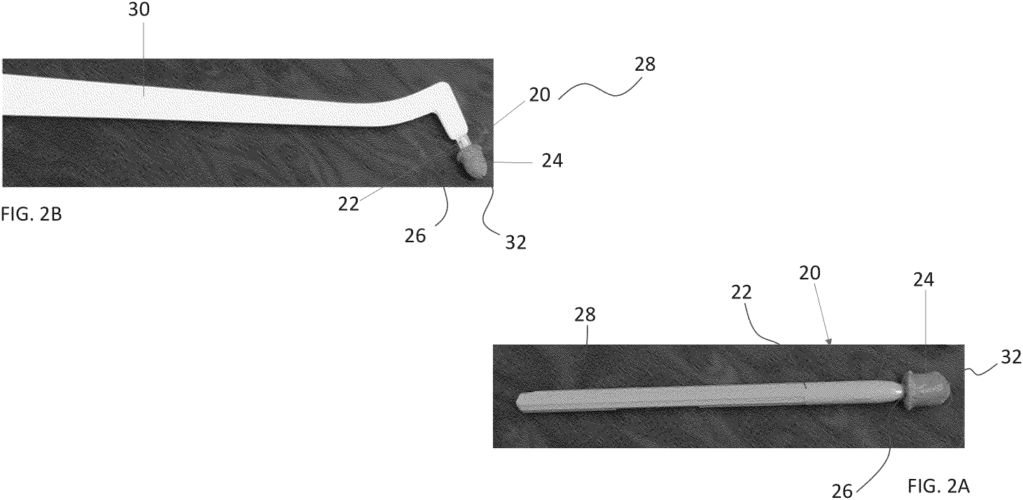

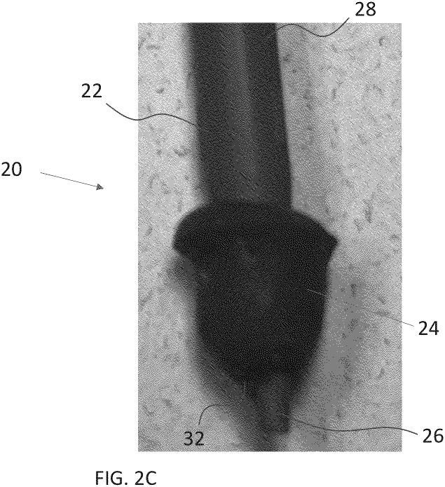

With reference now to FIGS. 1-2B, various examples of a disposable condensing tool 20 for use in a dental application is illustrated. As shown, the condensing tool 20 includes a post or shaft 22 and has a head 24 located at an end 26 of the shaft 22. In use, the free end 28 of the shaft 22 of the condensing tool 20 may be held directly by a user. However, in other embodiments, the condensing tool 20 may be configured or adapted for use with a handle 30 (see FIG. 2B). For example, the handle 30 may be configured to receive a plurality of interchangeable attachments and the condensing tool 20 may be one of the plurality of attachments. In such embodiments, the shaft 22 is receivable within an opening (not shown) formed in the handle 30.

In the illustrated, non-limiting embodiments, the head 24 is generally oval or cylindrical in shape, and the distal end 32 of the head 24 has a generally spherical or rounded contour. For example, in an embodiment, the shape of the distal end 32 of the head 24 is similar to the curvature of a fingertip. It should be understood that the head 24 illustrated and described herein is intended as an example only, and that any shape having a curved or rounded distal end 32 is within the scope of the disclosure. The size and/or shape of the condensing tool 20 may vary based on the dental application in which the condensing tool 20 is used. However, at least one dimension of the distal end 32 of the head 24 is typically larger than a corresponding dimension of an opening or channel within which the distal end 32 of the head 24 may be received.

In an embodiment, the head 24 is formed from a resilient or compressive material such that at least a portion of the head 24, for example the distal end 32 thereof, elastically deforms when arranged in contact with an adjacent surface. Further, the deformation of the head 24 that occurs includes conforming of the head 24 to the adjacent surface 42, such as a surface 42 of a tooth 40 for example. In an embodiment, the head 24 is formed from a light-bodied elastomeric material commonly used in the dental industry, such as to make dental impressions for example. Examples of such an elastomeric material that meets an ISO 4823 type 3 standard include, but are not limited to, a polyvinyl siloxane (PVS), condensation silicone, polyether, and polysulfide.

The condensing tool 20 may be used during the restoration of a tooth, such as when performing a restoration of a tooth associated with a carious lesion for example. However, it should be understood that the condensing tool 20 may be used when performing any type of restoration. The condensing tool 20 may be used to smooth and/or condense a restorative material as will be described in more detail below. Alternatively, or in addition, a force may be applied to the shaft 22 of the condensing tool 20 may causing the shaft to puncture or pierce through the head 24 ( see FIG. 2C). In such a configuration, the exposed end 26 of the shaft 22 may be used to apply a compressive force to a restorative material in a manner similar to a conventional plugger. It should be understood that a condensing tool 20 as described herein may be used in place of or in combination with existing pluggers and condensers.

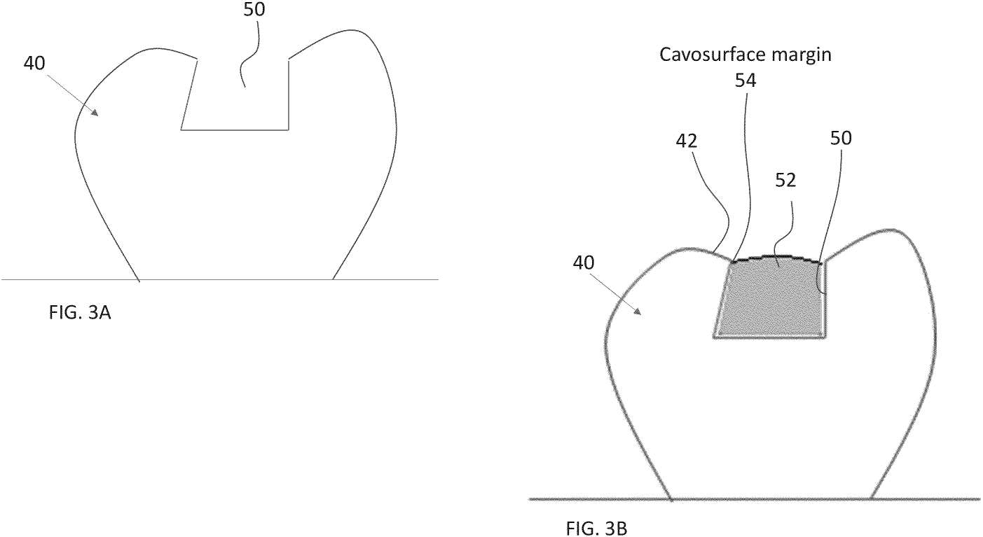

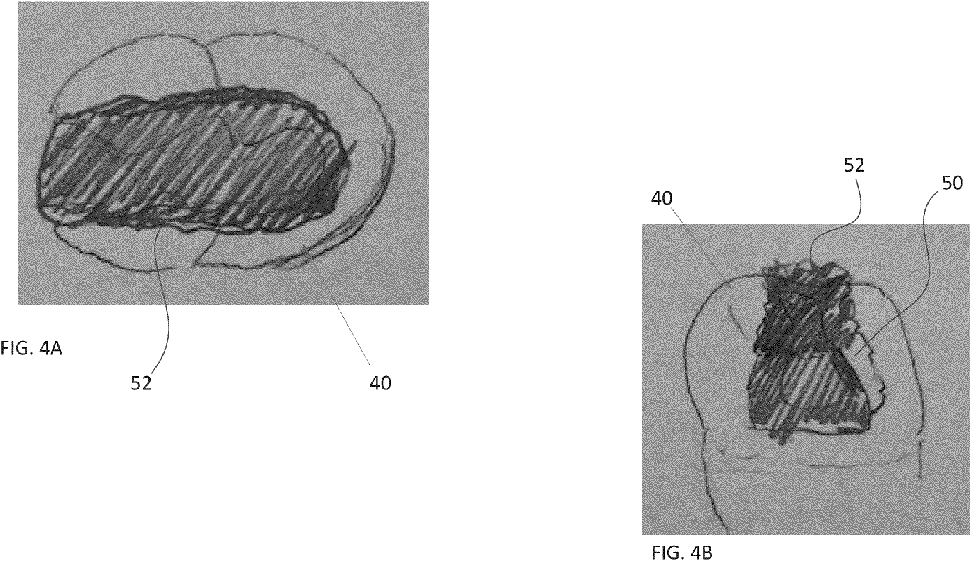

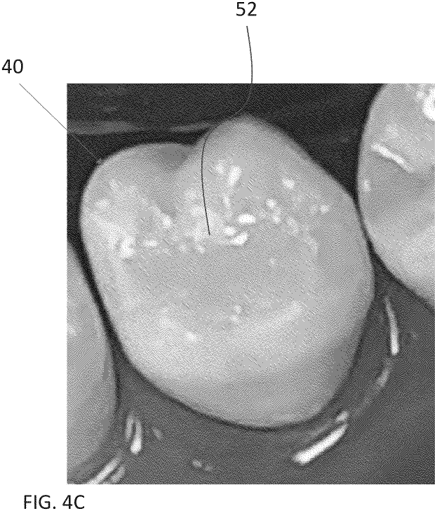

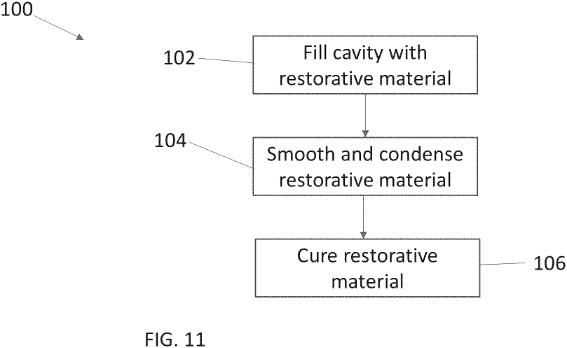

With reference now to FIG. 11, an example of a method 100 of restoring a tooth is illustrated in more detail. As shown, in block 102 a restorative material 52 is installed within the formed cavity 50 (see FIG. 3 and FIGS. 4A-4C). The cavity 50 may have been formed via any suitable method known in the art. For example, a cavity may be formed by first removing material from the structure of the tooth 40. Furthermore, prior to installation of the restorative material 52, the cavity may be prepares such as etched or conditioned to kill any bacteria present and then rinsed and/or dried. However, embodiments where the cavity is not etched, rinsed, or dried prior to installing the restorative material 52 are also contemplated herein.

In an embodiment, the entirety of the cavity 50 is filled with the restorative material 52. Examples of suitable restorative materials include, but are not limited to composite resin materials. Composite resin materials are typically made of glass or quartz with a resin medium. However, it should be understood that any suitable compressible material is within the scope of the disclosure. Unlike existing restorative procedures in which the restorative material 52 is gradually “built up” within the cavity 50 by installing and curing individual layers of restorative material, the entire cavity 50 may be filled as a single layer. However, embodiments, where the restorative material is gradually built up are also within the scope of the disclosure.

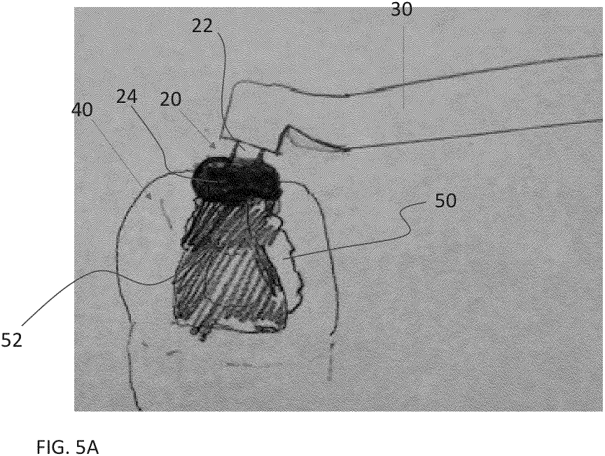

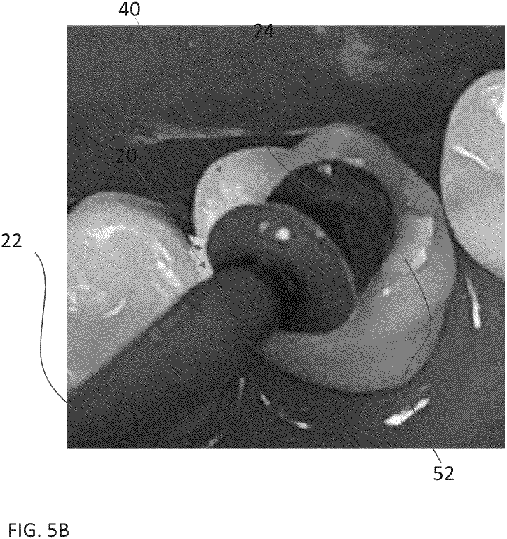

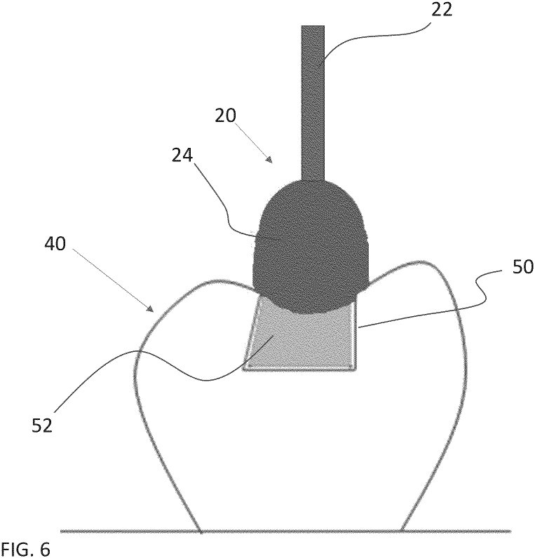

As shown in block 104, the uncured restorative material 52 within the cavity 50 is then condensed and smoothed. In an embodiment, the condensing and smoothing occurs simultaneously, such as via application of the condensing tool 20, see FIGS. 5A-6. To use the condensing tool 20, the distal end 32 of the tool 20 is first dipped into an unfilled resin material and is then moved, such as swiped for example, across the top of cavity 50 and the restorative material 52. The condensing tool 20 may be moved across the top of the cavity 50 a single time, or alternatively, multiple times, such as in the same direction or multiple directions. The application of the resin material to the elastomeric material of the head 24 forms a glass-like non-stick surface. This non-stick surface is what is configured to contact the restorative material 52.

The movement of the condensing tool 20 across the restorative material 52 and the adjacent portion of the tooth will coat the restorative material 52 with the resin material. In an embodiment, the presence of this resin material will prevent the formation of an oxygen inhibition layer at the surface of the restorative composite material 52 that is exposed to the atmosphere.

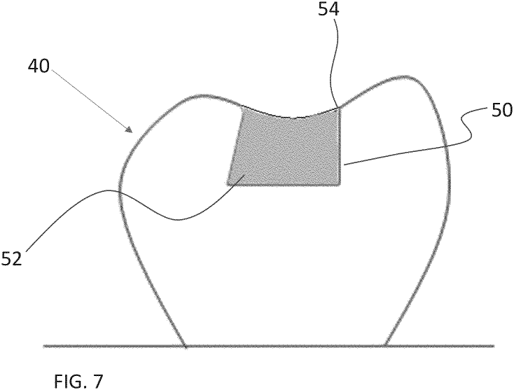

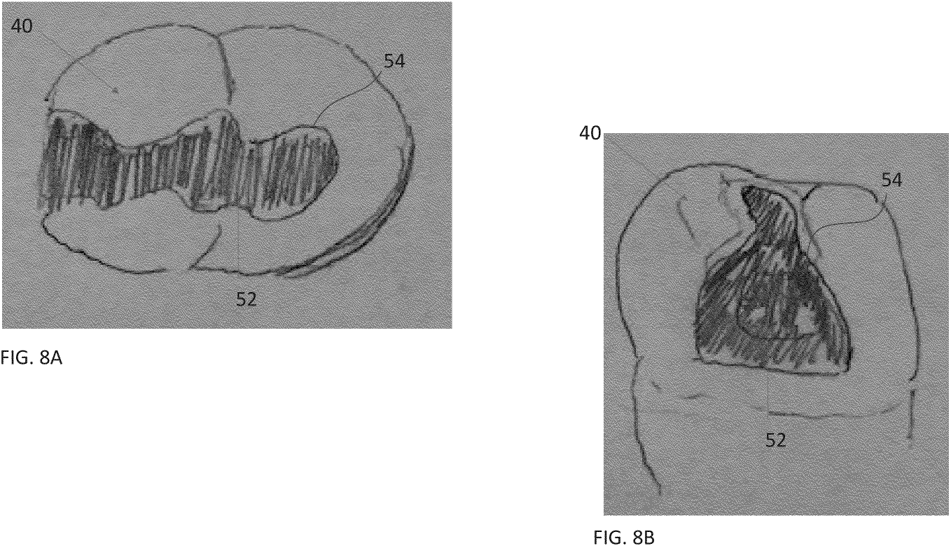

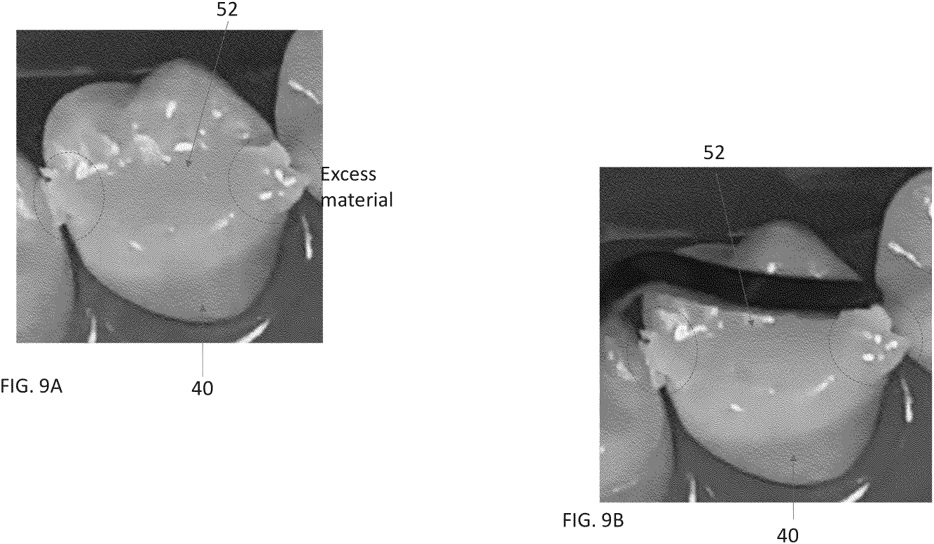

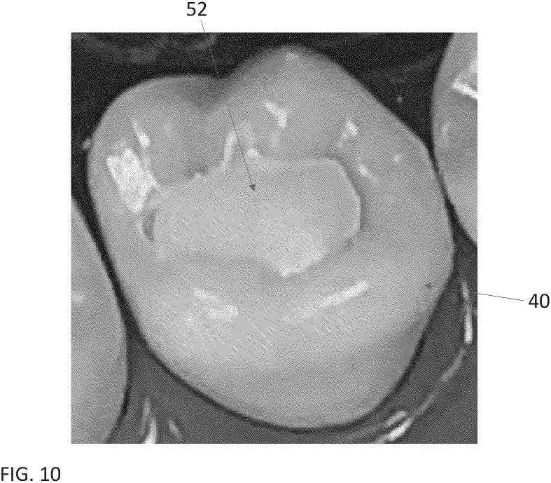

As the condensing tool 20 is moved across the cavity 50 and the upper surface of the restorative material 52, a slight pressure is applied to the condensing tool 20 in the direction of the tooth 40. This pressure causes the head 24 of the condensing tool 20 conform to the adjacent surfaces of the restorative material 52 and the adjacent tooth portion. This deformation causes the head 24 to adapt to the adjacent surfaces and maintain contact with the cavosurface margin 54, which is the interface between the tooth 40 and the cavity 50 (see FIG. 3), as the condensing tool 20 moves relative to the tooth 40. At the same time, the pressure applied by the head 24 to the restorative material 52 arranged within the cavity 50 condenses the restorative material 52, thereby eliminating any voids within the body of the restorative material 52. The pressure applied by the deformed head 24 of the condensing tool 20 also causes the restorative material 52 to seal against the cavosurface margin 54, reducing the potential for any voids at the cavosurface margin 54 (see FIG. 7). After the smoothing and condensing step in block 104 is complete, the condensing tool 20 may be disposed of or thrown away. As best shown in FIG. 9A, the smoothing and condensing performed with the condensing tool 20 may result in the accumulation of excess material, such as near an edge of the tooth for example. In such instances, the excess material may be wiped away or removed using a conventional plugger or other suitable tool (see FIG. 9B). An example of a tooth after the excess material is removed is shown in FIG. 10.

In block 106, the remaining smoothed and condensed restorative material 52 within the cavity 50 is then cured, such as via application of light having a specific wavelength thereto for example. While not wishing to be bound by any theory, it is believed that the movement in combination with the pressure applied to the restorative material 52 by the head 24 aligns the microspheres within the restorative material 52 in a more organized manner. General alignment of the microspheres allows the light having a specific wavelength, which acts as the curing catalyst, to penetrate more deeply through the restorative material 52, thereby eliminating the need to build up and cure the restorative material 52 in layers.

Use of a condensing tool 20 as described herein reduces the total time required to perform a tooth restoration, by smoothing, condensing, and removing excess restorative material from the cavity in a single step. Further, use of the condensing tool 20 reduces the total time required to perform a tooth restoration by eliminating the need to incrementally build up the restorative material 52 within the cavity 50.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A condensing tool for use in a dental application comprising:
a shaft;
a head arranged at an end of the shaft, a portion of the head being formed from a resilient material configured to deform when arranged in contact with an adjacent surface.

2. The condensing tool of claim 1, wherein the resilient material is an elastomeric material.

3. The condensing tool of claim 2, wherein the elastomeric material satisfies an ISO 4823 type 3 standard.

4. The condensing tool of claim 1, wherein a resin material is in overlapping arrangement with the portion of the head being formed from the resilient material.

5. The condensing tool of claim 1, wherein the condensing tool is connectable to a handle as one of a plurality of interchangeable attachments.

6. A method of restoring a tooth, comprising:
filling a cavity formed in the tooth with a restorative material;
smoothing the restorative material via a condensing tool;
condensing the restorative material via the condensing tool; and
curing the restorative material.

7. The method of claim 6, wherein smoothing and condensing the restorative material occurs simultaneously.

8. The method of claim 6, wherein smoothing and condensing the restorative material further comprises:
applying a pressure to the restorative material via the condensing tool; and
moving the condensing tool across an upper surface of the restorative material.

9. The method of claim 8, wherein applying the pressure to the restorative material via the condensing tool further comprises deforming the condensing tool against a surface of the tooth.

10. The method of claim 9, wherein deforming the condensing tool against the surface of the tooth maintains contact between the condensing tool and a cavosurface margin of the tooth.

11. The method of claim 10, wherein deforming the condensing tool against the surface of the tooth seals the restorative material against the cavosurface margin.

12. The method of claim 6, further comprising removing excess of the restorative material via the condensing tool.

13. The method of claim 12, wherein removing excess of the restorative material occurs simultaneously with at least one of the smoothing the restorative material and the condensing the restorative material.

14. The method of claim 6, further comprising coating a portion of the condensing tool configured to contact the restorative material with a resin material prior to at least one of the smoothing the restorative material and the condensing the restorative material.

15. The method of claim 6, wherein the cavity is filled with a single layer of the restorative material.

16. The method of claim 6, wherein the restorative material within the cavity is cured in a single operation.
